(19) United States
(12) Patent Application Publication
(10) Pub. No.: US 2007/0229719 A1
(43) Pub. Date: Oct. 4, 2007

(54) REAR-PROJECTION DISPLAY APPARATUS AND AN IMAGE ADJUSTMENT METHOD THEREOF

(75) Inventors: Wei-Cheng Huang, Hsinchu (TW); Wen-Tsai Cheng, Hsinchu (TW); Chih-Lung Chang, Hsinchu (TW)

Correspondence Address: FROMMER LAWRENCE & HAUG, 745 FIFTH AVENUE- 10TH FL., NEW YORK, NY, 10151, US

(73) Assignee: CORETRONIC CORPORATION

(21) Appl. No.: 11/649,063

(22) Filed: Jan. 3, 2007

(30) Foreign Application Priority Data
Mar. 31, 2006 (TW) 095111493

(51) Int. Cl. H04N 17/02; H04N 3/26

(52) U.S. Cl. 348/745; 348/189

(57) ABSTRACT

A rear-projection display apparatus includes a housing, a screen mounted on the housing, an optical engine mounted in the housing, and a host unit mounted in the housing and coupled to the optical engine. The host unit includes an on screen display module having an image alignment unit that is operable in an image-alignment mode to enable the optical engine to project a test pattern onto the screen. The image alignment unit is operable to adjust display of the test pattern projected by the optical engine onto the screen such that the test pattern thus displayed is within a predefined range of the screen when the image alignment unit is operated in the image-alignment mode.

### CROSS-REFERENCE TO RELATED APPLICATION

This application claims priority of Taiwanese Application No. 095111493, filed on Mar. 31, 2006.

### BACKGROUND OF THE INVENTION

1. Field of the Invention

The invention relates to a display apparatus, more particularly to a rear-projection display apparatus and an image adjustment method thereof.

2. Description of the Related Art

As shown in FIG. 1, image light for a conventional rear-projection display apparatus 12 is generated by an optical engine 13 mounted in a housing 11 of the conventional rear-projection display apparatus 12. The image light is reflected by mirrors 14, 16 and is eventually projected to display an image onto a screen 15 of the conventional rear-projection display apparatus 12. The abovementioned components are required to be precisely positioned relative to each other in order to prevent image distortion so as to ensure quality of the image. However, position of the image projected does not necessarily fall within peripheral edges defined by the screen 15 due to manufacturing tolerances of individual components in the assembled display apparatus 12. Therefore, an image alignment procedure is required to be performed for the conventional rear-projection display apparatus 12 before the conventional rear-projection display apparatus 12 is sold to consumers.

The conventional image alignment method is accomplished by first providing an adjusting seat 20 for mounting of the optical engine 13 thereon. Preliminary adjustment of the position of the optical engine 13 in the housing 11 is performed by adjusting the position of the adjusting seat 20 in linear directions. Subsequently, with further reference to FIG. 2, an image generator 10 is coupled externally to the conventional rear-projection display apparatus 12 via a signal transmission cable 17 for providing a test pattern 100 (as shown in FIG. 3) to the conventional rear-projection display apparatus 12. An operator (not shown) at the production line of the rear-projection display apparatus 12 adjusts the adjusting seat 20 according to the display of the test pattern 100 on the screen 15. Take the test pattern 100 shown in FIG. 3 as an example. The display of test pattern 100 on the screen 15 falls outside of the peripheral edges defined by the screen 15. Therefore, the operator needs to move the test pattern 100 by adjusting the adjusting seat 20 so that the test pattern 100 falls within the peripheral edges defined by the screen 15, as shown in FIG. 4.

In conclusion, the conventional image alignment method uses wired transmission for providing the test pattern 100 to the conventional rear-projection display apparatus 12. The image generator 10 not only increases production cost, but is also troublesome to carry around. In addition, the image generator 10 needs to be plugged and unplugged repeatedly in order to be used on different rear-projection display apparatuses 12. This plugging and unplugging process is inconvenient, and slows down the image alignment procedure, making the image alignment procedure inefficient. Moreover, since the operator who carries out the image alignment procedure needs to use his bare vision to determine the position of the display of the test pattern 100 on the screen 15, precision in image adjustment is poor. Further, the size of the test pattern 100 is fixed so that the test pattern 100 is only suitable for a specific quality requirement.

### SUMMARY OF THE INVENTION

Therefore, the main object of the present invention is to provide a rear-projection display apparatus and an image adjustment method thereof such that image alignment of the rear-projection display apparatus is convenient to perform, no plugging and unplugging of external hardware is required, and efficiency of image alignment in a production line can be increased.

Another object of the present invention is to provide a rear-projection display apparatus and an image adjustment method thereof increases alignment precision as compared to the prior art.

According to one aspect of the present invention, a rear-projection display apparatus is provided and includes a housing, a screen mounted on the housing, an optical engine mounted in the housing, and a host unit mounted in the housing and coupled to the optical engine. The host unit includes an on screen display module having an image alignment unit that is operable in an image-alignment mode so as to enable the optical engine to project a test pattern onto the screen. The image alignment unit is operable to adjust display of the test pattern such that the test pattern displayed is within a predefined range of the screen when the image alignment unit is operated in the image-alignment mode.

Preferably, the image alignment unit enables the optical engine to project the test pattern with a color indicative of whether or not the display of the test pattern on the screen is within the predefined range.

According to another aspect of the present invention, a method of image adjustment for a rear-projection display apparatus is provided. The method includes the steps of: activating an image alignment unit via remote control for enabling an optical engine to project a test pattern onto a screen of the rear-projection display apparatus; and controlling the image alignment unit via remote control for adjusting display of the test pattern projected by the optical engine onto the screen such that the test pattern thus displayed is within a predefined range of the screen.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional rear-projection display apparatus;

FIG. 2 is a perspective view of the conventional rear-projection display apparatus, illustrating external coupling of an image generator thereto;

FIG. 3 is a schematic diagram, illustrating display of a test pattern on a screen of the conventional rear-projection display apparatus prior to image alignment;

FIG. 4 is a schematic diagram, illustrating the display of the test pattern on the screen of the conventional rear-projection display apparatus after image alignment;

FIG. 5 is a perspective view of the preferred embodiment of a rear-projection display apparatus according to the present invention;

FIG. 6 is a schematic block diagram of the preferred embodiment;

FIG. 7 is a schematic diagram of a screen according to the preferred embodiment, illustrating a standard range and a tolerable range of the screen;

FIG. 8 is a flow chart of an image adjustment method according to the preferred embodiment;

FIG. 9 is a schematic diagram, illustrating an exemplary display of a test pattern on the screen;

FIG. 10 is a schematic diagram, illustrating another exemplary display of a test pattern on the screen;

FIG. 11 is a schematic diagram, illustrating yet another exemplary display of a test pattern on the screen;

FIG. 12 is a schematic diagram, illustrating still another exemplary display of a test pattern on the screen;

FIG. 13 is a schematic diagram, illustrating a different exemplary display of a test pattern on the screen; and

FIG. 14 is a schematic diagram, illustrating another exemplary display of a test pattern on the screen.

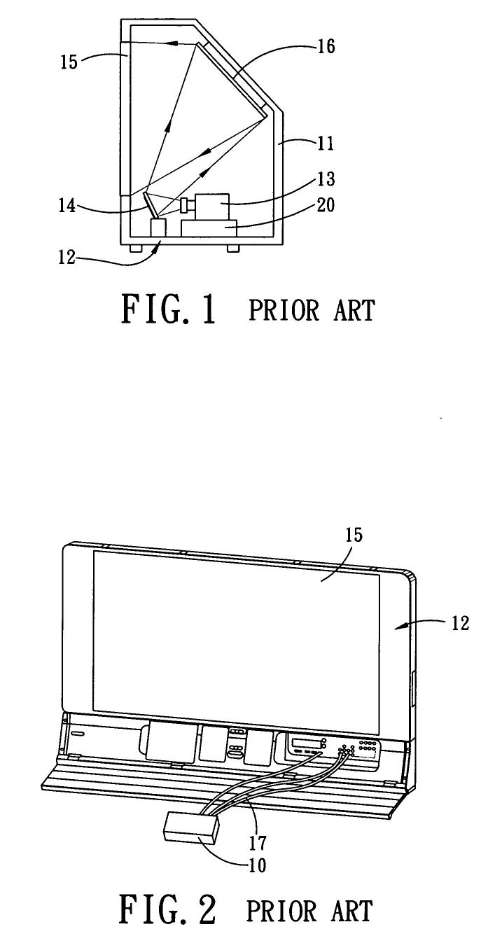

### DETAILED DESCRIPTION OF THE PREFERRED EMBODIMENT

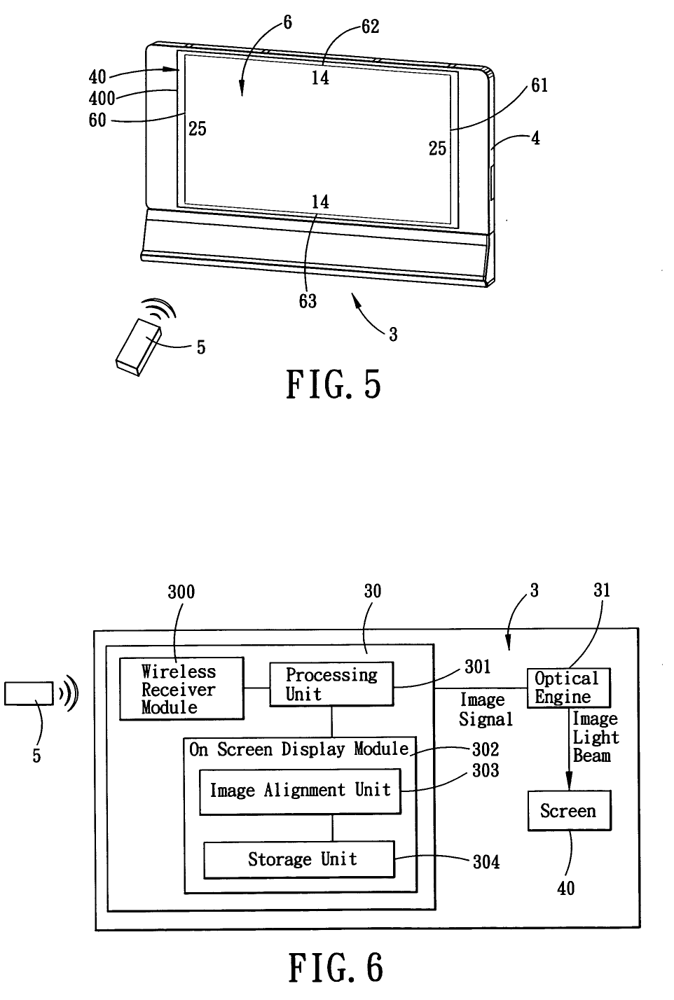

As shown in FIG. 5 and FIG. 6, the preferred embodiment of a rear-projection display apparatus 3 according to the present invention is controllable by a portable remote control device 5, such as but not limited to a remote controller or a personal digital assistant (PDA) equipped with wireless control capability. The rear-projection display apparatus 3 includes a housing 4, a host unit 30, an optical engine 31, and a screen 40. The host unit 30 and the optical engine 31 are mounted in the housing 4, and the screen 40 is mounted on and is disposed at a front side of the housing 4. The host unit 30 is coupled to the optical engine 31 for providing image signals to the optical engine 31. The optical engine 31 converts the image signal received from the host unit 30 into an image light beam, and projects the image light beam to display an image onto the screen 40.

The host unit 30 includes a wireless receiver module 300, a processing unit 301, and an on screen display module 302. The processing unit 301 is coupled to the wireless receiver module 300 and the on screen display module 302. The wireless receiver module 300 receives wirelessly a remote control signal from the portable remote control device 5. The processing unit 301 outputs a control command that corresponds to the remote control signal received by the wireless receiver module 300 to the on screen display module 302.

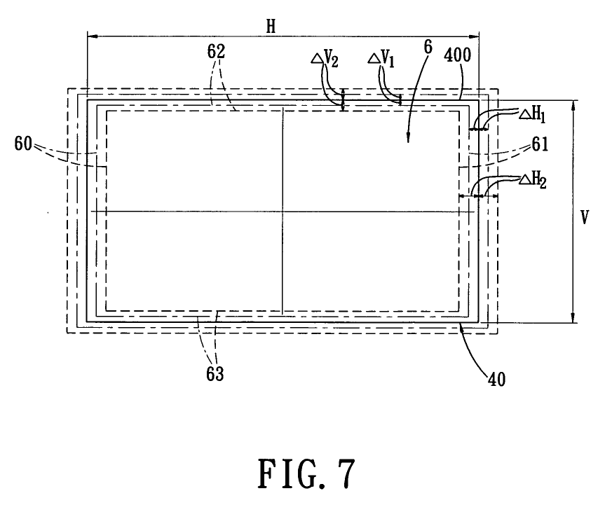

The on screen display module 302 has an image alignment unit 303 and a storage unit 304. The image alignment unit 303 is operable in an image-alignment mode so as to enable the optical engine 31 to project a test pattern 6 (as shown in FIG. 7) onto the screen 40. The image alignment unit 303 is further operable so as to adjust display of the test pattern 6 projected by the optical engine 31 onto the screen 40 such that the test pattern 6 is displayed within a predefined range of the screen 40 when the image alignment unit 303 is operated in the image-alignment mode. In particular, the image alignment unit 303 adjusts the display of the test pattern 6 projected onto the screen 40 according to the control command received by the on screen display module 300 when the image alignment unit 303 is operated in the image-alignment mode. The image alignment unit 303 is implemented as firmware or a readable memory (e.g., a flash memory) that is loaded with proprietary software. The storage unit 304 is coupled to the image alignment unit 303 for storing alignment data obtained upon adjustment of the display of the test pattern 6 by the image alignment unit 303.

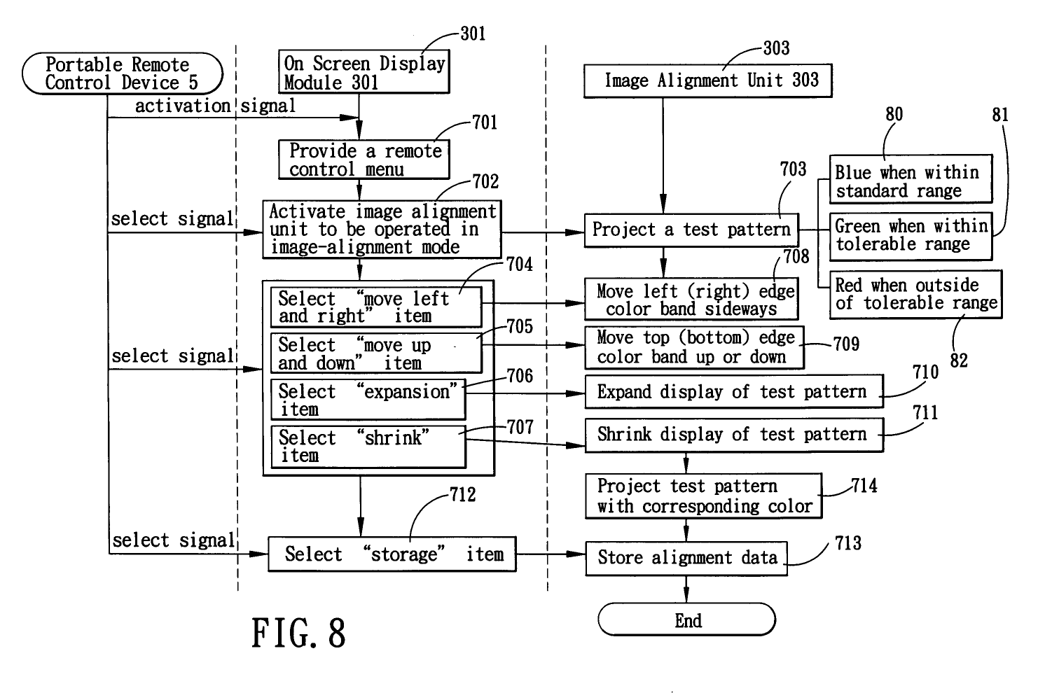

With further reference to FIG. 7 and FIG. 8, to perform image alignment, an operator (not shown) first uses the portable remote control device 5 to output a wireless activation signal to be received by the wireless receiver module 300 of the host unit 30. The processing unit 301 then outputs a control command to control the on screen display module 302 so as to provide a remote control menu (not shown), which is projected onto the screen 40 by the optical engine 31 (step 701). Subsequently, an image alignment item (not shown) of the remote control menu is selected by sending a wireless select signal from the portable remote control device 5 to activate operation of the image alignment unit 303 in the image-alignment mode (step 702). Upon activation of the image alignment unit 303, the optical engine 31 is enabled to project the test pattern 6 onto the screen 40 (step 703).

In this embodiment, the test pattern 6 is a rectangular frame. The test pattern 6 includes left and right edge color bands 60, 61 that are parallel to each other, and top and bottom edge color bands 62, 63 that are parallel to each other. Proximate to each of the color bands 60, 61, 62, 63 is a numerical value representing the distance in pixels measured from the color bands 60, 61, 62, 63 to a corresponding edge of an outer periphery 400 of the screen 40. For example, referring to FIG. 5, the top edge color band 62 is shown to be 14 pixels away from a top edge of the outer periphery 400 of the screen 40. The same can be found with the left, right and bottom edge color bands 60, 61, 63 and will not be described further herein.

The image alignment unit 303 provides the test pattern 6 to the optical engine 3, and the image alignment unit 303 is able to determine if the test pattern 6 is within the range of the optical engine 3. If the test pattern 6 is not within the range of the optical engine 3, the test pattern 6 projected by the optical engine 3 is also not within the predefined range of the displays screen 40. As described in blocks 80, 81 and 82 in FIG. 8, the image alignment unit 303 enables the optical engine 31 to project the test pattern 6 with different colors according to the location of the display of the test pattern 6 on the screen 40. In particular, the predefined range of the screen 40 is a standard range or a tolerable range. The image alignment unit 303 enables the optical engine 31 to project the test pattern 6 with a first color, i.e., light blue in this embodiment, when the display of the test pattern 6 on the screen 40 is within the standard range. The image alignment unit 303 enables the optical engine 31 to project the test pattern 6 with a second color, i.e., light green in this embodiment, when the display of the test pattern 6 on the screen 40 is within the tolerable range. The image alignment unit 303 enables the optical engine 31 to project the test pattern 6 with a third color, i.e., light red in this embodiment, when the display of the test pattern 6 on the screen 40 is outside the tolerable range.

The standard range and the tolerable range are defined after performing a distortion (tolerance) analysis during design phase of the image alignment unit 303. In this embodiment, the standard range is defined as follows:

As shown in FIG. 7, ΔH₁=H×±0.5%, where ΔH₁ is the standard distance between each of the left and right edge color bands 60, 61 and the respective one of left and right edges of the outer periphery 400 of the screen 40, and H is the horizontal width of the outer periphery 400; ΔV₁=V×±0.5, where ΔV₁ is the standard distance between each of the top and bottom edge color bands 62, 63 and the respective one of top and bottom edges of the outer periphery 400 of the screen 40, and V is the vertical length of the outer periphery 400. In this embodiment, the tolerable range is defined as follows:

As shown in FIG. 7, ΔH₂=H×±1.0%, where ΔH₂ is the tolerable distance between each of the left and right edge color bands 60, 61 and the respective one of the left and right edges of the outer periphery 400 of the screen 40, and H is the horizontal width of the outer periphery 400; ΔV₂=V×±1.0%, where ΔV₂ is the tolerable distance between each of the top and bottom edge color bands 62, 63 and the respective one of the top and bottom edges of the outer periphery 400 of the screen 40, and V is the vertical length of the outer periphery 400.

After the test pattern 6 is projected onto the screen 40 by the optical engine 31, the operator refers to the location and the color of the test pattern 6 thus displayed, and controls the image alignment unit 303 via the portable remote control device 5 for adjusting the display of the test pattern 6 on the screen 40 such that the test pattern 6 thus displayed is within the predefined range (i.e., the standard range or the tolerable range) of the screen 40.

In this embodiment, the remote control menu (not shown) includes a “move left and right” item, a “move up and down” item, an “expansion” item, and a “shrink” item. When the “move left and right” item is selected via the portable remote control device 5, where the portable remote control device 5 sends a move left or move right remote control signal to the wireless receiver module 300, the processing unit 301 outputs a control command to the on screen display module 302 corresponding to the move left or move right remote control signal received by the wireless receiver module 300 from the portable remote control device 5 (step 704). The image alignment unit 303 then responds by adjusting the display of the test pattern 6 on the screen 40 such that a specified one of the left and right edge color bands 60, 61 is moved sideways toward the left or toward the right (step 708). When the “move up and down” item is selected via the portable remote control device 5, where the portable remote control device 5 sends a move up or move down remote control signal to the wireless receiver module 300, the processing unit 301 outputs a control command to the on screen display module 302 corresponding to the move up or move down remote control signal received by the wireless receiver module 300 from the portable remote control device 5 (step 705). The image alignment unit 303 then responds by adjusting the display of the test pattern 6 on the screen 40 such that a specified one of the top and bottom edge color bands 62, 63 is moved upwards or downwards (step 709). When the “expansion” item is selected via the portable remote control device 5, where the portable remote control device 5 sends an expansion remote control signal to the wireless receiver module 300, the processing unit 301 outputs a control command to the on screen display module 302 corresponding to the expansion remote control signal received by the wireless receiver module 300 from the portable remote control device 5 (step 706). Accordingly, the image alignment unit 303 is controlled to expand the test pattern 6 displayed on the screen 40 (step 710). When the “shrink” item is selected via the portable remote control device 5, where the portable remote control device 5 sends a shrink remote control signal to the wireless receiver module 300, the processing unit 301 outputs a control command to the on screen display module 302 corresponding to the shrink remote control signal received by the wireless receiver module 300 from the portable remote control device 5 (step 707). Accordingly, the image alignment unit 303 is controlled to shrink the test pattern 6 displayed on the screen 40 (step 711).

By selectively performing the abovementioned steps, the operator is able to adjust the display of the test pattern 6 to be within the predefined range of the screen 40. Take the predefined range to be the tolerable range as an example. In this embodiment, the tolerable range ΔH₂ for each of the left and right edge color bands 60, 61 is 25 pixels, and the tolerable range ΔV₂ for each of the top and bottom edge color bands 62, 63 is 14 pixels. It should be noted herein that the tolerable range is not limited to the values provided above, but can be predefined in the image alignment unit 303 according to specific requirements set forth by the manufacturer. The image alignment unit 303 enables the optical engine 31 to project the test pattern 6 with the green color when the display of the test pattern 6 is within the tolerable range to visually inform the operator of the same (step 714).

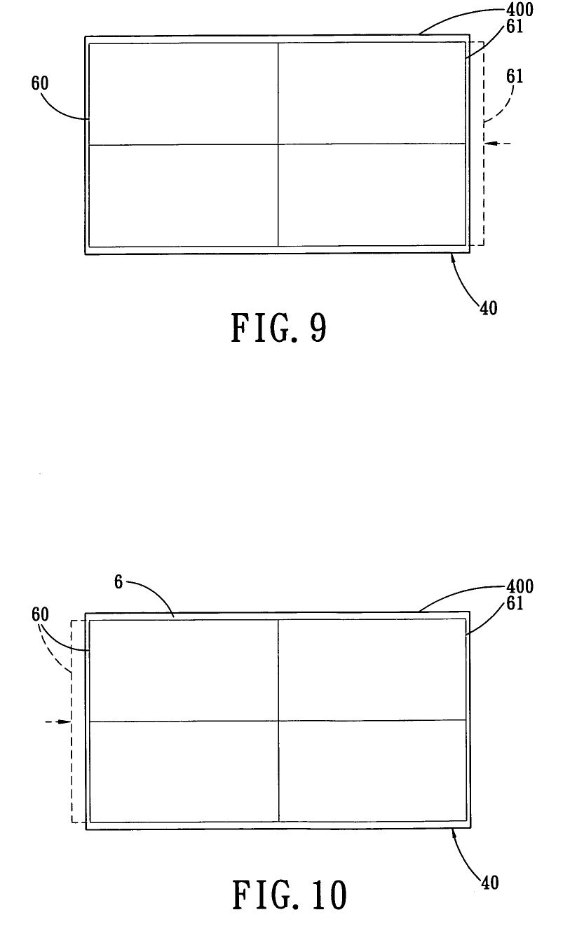

FIG. 9 illustrates an exemplary display of the test pattern 6 on the screen 40, where the dotted line on the right represents the right edge color band 61 prior to image alignment. Since the dotted line exceeds the right edge of the outer periphery 400 of the screen 40, the operator controls the image alignment unit 303 to move the right edge color band 61 to the left (step 704 in FIG. 8) such that the right edge color band 61 is within the tolerable range ΔH₂, i.e., within 25 pixels from the right edge of the outer periphery 400 of the screen (step 708). FIG. 10 illustrates another exemplary display of the test pattern 6 on the screen 40, where the dotted line on the left represents the left edge color band 60 prior to image alignment. Similarly, since the dotted line exceeds the left edge of the outer periphery 400 of the screen 40, the operator controls the image alignment unit 303 to move the left edge color band 60 to the right (step 704) such that the left edge color band 60 is within the tolerable range ΔH₂, i.e., within 25 pixels from the left edge of the outer periphery 400 of the screen (step 708).

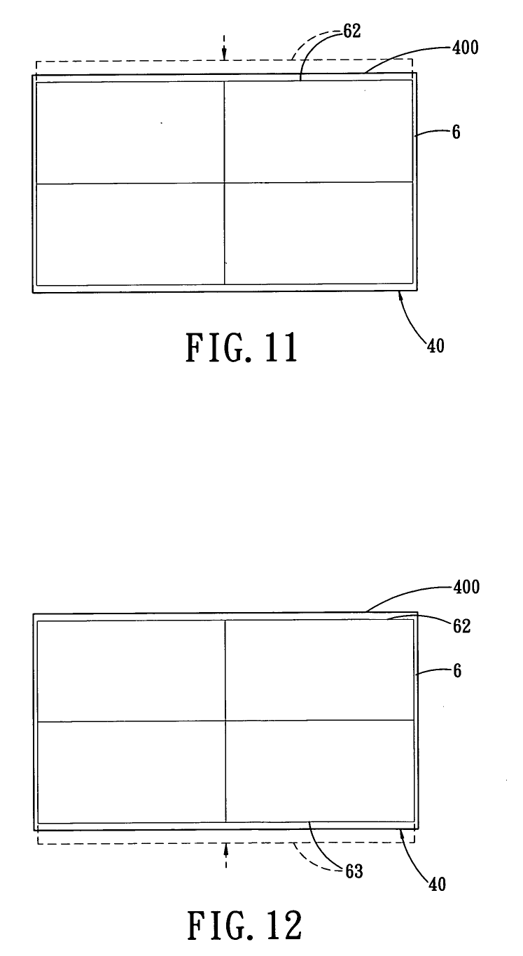

FIG. 11 illustrates yet another exemplary display of the test pattern 6 on the screen 40, where the dotted line on the top represents the top edge color band 62 prior to image alignment. Since the dotted line exceeds the top edge of the outer periphery 400 of the screen 40, the operator controls the image alignment unit 303 to move the top edge color band 62 downwardly (step 705 in FIG. 8) such that the top edge color band 62 is within the tolerable range ΔV₂, i.e., within 14 pixels from the top edge of the outer periphery 400 of the screen (step 709). FIG. 12 illustrates still another exemplary display of the test pattern 6 on the screen 40, where the dotted line on the bottom represents the bottom edge color band 63 prior to image alignment. Similarly, since the dotted line exceeds the bottom edge of the outer periphery 400 of the screen 40, the operator controls the image alignment unit 303 to move the bottom edge color band 63 upwardly (step 705) such that the bottom edge color band 63 is within the tolerable range ΔV₂, i.e., within 14 pixels from the bottom edge of the outer periphery 400 of the screen (step 709).

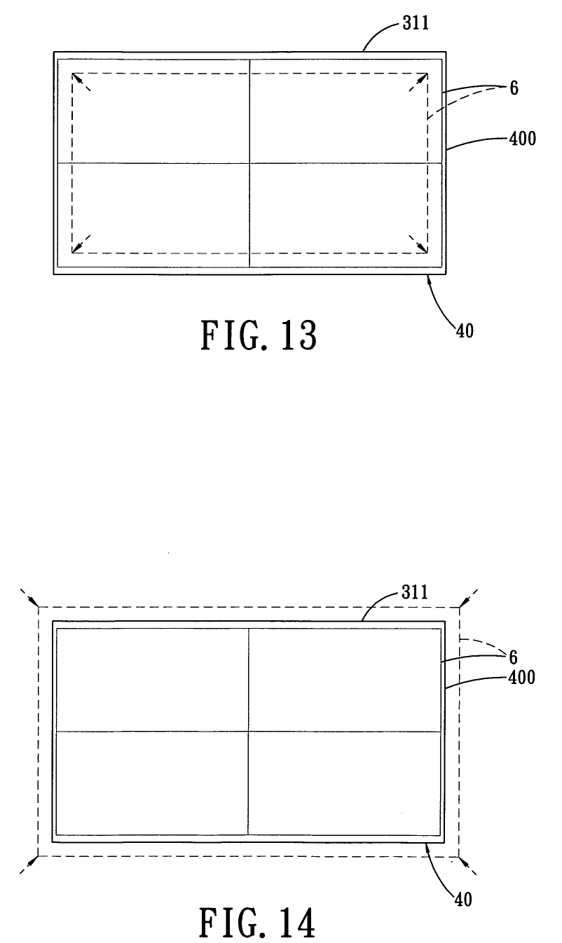

FIG. 13 illustrates a different exemplary display of the test pattern 6 on the screen 40, where the dotted lines represent the four color bands 60, 61, 62, 63 prior to image alignment. Since the area defined by the dotted lines is smaller than that defined by the outer periphery 400 of the screen 40, and is outside of the tolerable range of the screen 40, the operator controls the image alignment unit 303 to expand the test pattern 6 (step 706) such that the test pattern 6 is expanded in directions shown by the arrows in FIG. 13 until the display of the test pattern 6 is within the tolerable range (step 710).

FIG. 14 illustrates another exemplary display of the test pattern 6 on the screen 40, where the dotted lines represent the four color bands 60, 61, 62, 63 prior to image alignment. Since the area defined by the dotted lines is bigger than that defined by the outer periphery 400 of the screen 40, and is outside the tolerable range of the screen 40, the operator controls the image alignment unit 303 to shrink the test pattern 6 (step 707) such that the test pattern 6 is contracted in directions shown by the arrows in FIG. 14 until the display of the test pattern 6 is within the tolerable range (step 711).

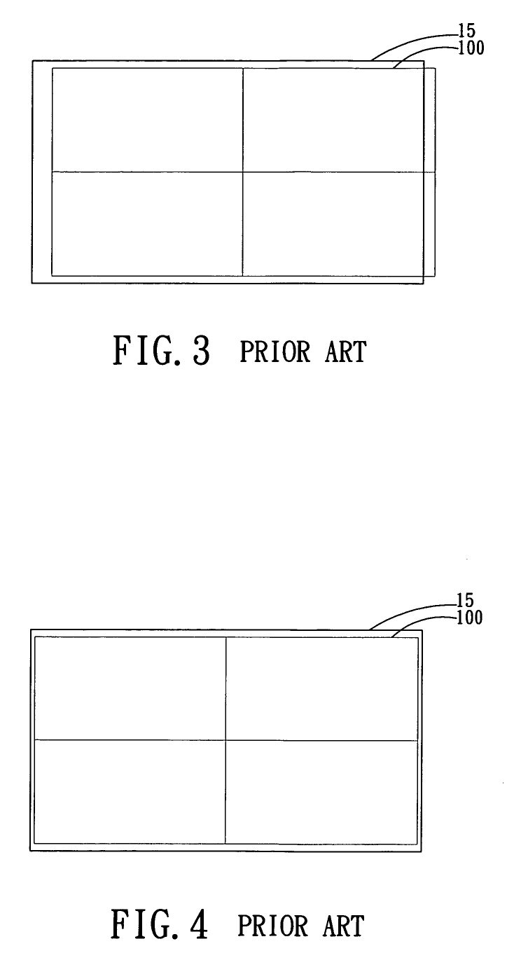

Referring back to FIG. 3, FIG. 6 and FIG. 8, after completing image adjustment, the operator controls the portable remote control device 5 to select a “storage” item of the remote control menu (step 712). The image alignment unit 303 then responds by storing in the storage unit 304 alignment data obtained by the image alignment unit 303 upon adjustment of the display of the test pattern 6 (step 713). After this step, the image alignment procedure is completed, and the image alignment unit 303 is operable in an image-viewing mode, in which the images to be projected by the optical engine 31 onto the screen 40 are adjustable according to the alignment data stored in the storage unit 304 so that the images projected by the optical engine 31 and displayed on the screen 40 are within the predefined range of the screen 40.

In sum, according to the present invention, during image alignment of the rear-projection display apparatus 3, the operator only needs to use the portable remote control device 5 to activate the on screen display module 302 and to perform the necessary adjustments to the display of the test pattern 6 generated by the image alignment unit 303 and projected by the optical engine 31 onto the screen 40 to make the display of the test pattern 6 be within the predefined range of the screen 40. Compared to the prior art, where external hardware is required to be plugged into and unplugged from the rear-projection display apparatus, and where a wired connection is used to generate the test pattern, the present invention provides an easy, efficient and convenient way of image alignment, which is particularly advantageous for the production line of the rear-projection display apparatus 3, where numerous adjustments are required to be performed daily.

In addition, since the image alignment unit 303 is capable of enabling the optical engine 31 to project the test pattern 6 with the first, second, and third colors when the display of the test pattern 6 is located differently relative to the screen 40 and with respect to the standard and the tolerable ranges, a visual reference is thus provided to the operator performing image adjustment to aid the operator in determining which step is required to be taken during the image alignment procedure. Moreover, other than adjusting the display of the test pattern 6 as a whole, the left, right, top and bottom edge color bands 60, 61, 62, 63 can be adjusted independently. Therefore, the image adjustment method according to the present invention is more flexible and more precise than the prior art, and is thus performed with improved quality and consistency.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A rear-projection display apparatus comprising:
a housing;
a screen mounted on said housing;
an optical engine mounted in said housing; and
a host unit mounted in said housing and coupled to said optical engine, said host unit including an on screen display module having an image alignment unit that is operable in an image-alignment mode to enable said optical engine to project a test pattern onto said screen, said image alignment unit being operable to adjust display of the test pattern, and the test pattern displayed being within a predefined range of said screen when said image alignment unit is operated in the image-alignment mode.

2. The rear-projection display apparatus as claimed in claim 1, wherein said host unit further includes:
a wireless receiver module adapted for receiving wirelessly a remote control signal; and
a processing unit coupled to said wireless receiver module and said on screen display module, said processing unit outputting a control command that corresponds to the remote control signal to said image alignment unit, said image alignment unit adjusting the display of the test pattern projected onto said screen according to the control command when said image alignment unit is operated in the image-alignment mode.

3. The rear-projection display apparatus as claimed in claim 2, wherein:
the predefined range is a standard range and a tolerable range alternatively;
said image alignment unit enables said optical engine to project the test pattern with a first color when the display of the test pattern on said screen is within the standard range;
said image alignment unit enables said optical engine to project the test pattern with a second color different from the first color when the display of the test pattern on said screen is within the tolerable range; and
said image alignment unit enables said optical engine to project the test pattern with a third color different from the first and second colors when the display of the test pattern on said screen is outside the tolerable range.

4. The rear-projection display apparatus as claimed in claim 2, wherein the test pattern includes left and right edge color bands, said image alignment unit being operable to adjust the display of the test pattern on said screen when said image alignment unit is operated in the image-alignment mode, where the left and right edge color bands is moved sideways alternatively according to the control command.

5. The rear-projection display apparatus as claimed in claim 2, wherein the test pattern includes top and bottom edge color bands, said image alignment unit being operable to adjust the display of the test pattern on said screen when said image alignment unit is operated in the image-alignment mode, where the top and bottom edge color bands is moved upwards and downwards alternatively according to the control command.

6. The rear-projection display apparatus as claimed in claim 2, wherein said image alignment unit is operable to expand the test pattern displayed on said screen according to the control command when operated in the image-alignment mode.

7. The rear-projection display apparatus as claimed in claim 2, wherein said image alignment unit is operable to shrink the test pattern displayed on said screen according to the control command when operated in the image-alignment mode.

8. The rear-projection display apparatus as claimed in claim 1, wherein said on screen display module further includes a storage unit coupled to said image alignment unit for storing alignment data obtained upon adjustment of the display of the test pattern by said image alignment unit.

9. The rear-projection display apparatus as claimed in claim 8, wherein said image alignment unit is further operable in an image-viewing mode in which images to be projected by said optical engine onto said screen are adjustable according to the alignment data stored in said storage unit, the images projected by said optical engine and displayed on said screen being within the predefined range of said screen.

10. A method of image adjustment for a rear-projection display apparatus, comprising the steps of:
a) activating an image alignment unit via remote control for enabling an optical engine to project a test pattern onto a screen of the rear-projection display apparatus; and
b) controlling the image alignment unit via remote control for adjusting display of the test pattern projected by the optical engine onto the screen, the test pattern thus displayed being within a predefined range of the screen.

11. The method as claimed in claim 10, wherein the predefined range is a standard range, and step b) further includes displaying the test pattern with a first color when the display of the test pattern on the screen is determined to be within the standard range.

12. The method as claimed in claim 10, wherein the predefined range is a tolerable range, and step b) further includes displaying the test pattern with a second color when the display of the test pattern on the screen is determined to be within the tolerable range.

13. The method as claimed in claim 10, wherein the predefined range is a tolerable range, and step b) further includes displaying the test pattern with a third color when the display of the test pattern on the screen is determined to be outside the tolerable range.

14. The method as claimed in claim 10, wherein the test pattern includes left and right edge color bands, and wherein, in step b), the image alignment unit is controlled via remote control to adjust the display of the test pattern on the screen, where the left and right edge color bands is moved sideways, alternatively.

15. The method as claimed in claim 10, wherein the test pattern includes top and bottom edge color bands, and wherein, in step b), the image alignment unit is controlled via remote control to adjust the display of the test pattern on the screen, where the top and bottom edge color bands is moved upwards and downwards alternatively.

16. The method as claimed in claim 10, wherein, in step b), the image alignment unit is controlled via remote control to expand the test pattern displayed on the screen.

17. The method as claimed in claim 10, wherein, in step b), the image alignment unit is controlled via remote control to shrink the test pattern displayed on the screen.

18. The method as claimed in claim 10, further comprising:
c) controlling the image alignment unit via remote control for storing in a storage unit alignment data obtained by the image alignment unit upon adjustment of the display of the test pattern.

19. The method as claimed in claim 18, further comprising:
d) controlling the image alignment unit, wherein images to be projected by the optical engine onto the screen are adjustable according to the alignment data stored in the storage unit, the images projected by the optical engine and displayed on the screen are within the predefined range of the screen.
